(19) United States
(12) Patent Application Publication
(10) Pub. No.: US 2015/0048092 A1
(43) Pub. Date: Feb. 19, 2015

(54) HOUSING FOR REFUSE AND/OR RECYCLING RECEPTACLES

(71) Applicant: WILLIAM KELLY, Long Beach, CA (US)

(72) Inventor: WILLIAM KELLY, Long Beach, CA (US)

(21) Appl. No.: 13/967,347

(22) Filed: Aug. 15, 2013

(51) Int. Cl. B65F 1/14

(52) U.S. Cl. CPC B65F 1/1426
USPC 220/495.01

(57) ABSTRACT

A Housing for Refuse and/or Recycling Receptacles includes a Pre-Scored Cardboard Planar Member. The planar member is scored to facilitate the easy and accurate folding of the planar member into the housing. The Housing is roughly analogous to a basketball hoop assembly and is placed over a refuse or recycling receptacle.

### FIELD OF THE INVENTION

The present invention is in the area of containers and more particularly pertains to a Housing for Refuse and/or Recycling Receptacles for providing an aesthetic and functional covering for trash and/or recycling receptacles.

### BACKGROUND

As the global population has surpassed seven billion people, its rapid approach to ten billion people will be inexorably accompanied with a exponential depletion of natural resources upon which modern society operates. Natural resources such as the metals are not renewable in contrast with glass, plastic, or paper. However, even though glass is a renewable resource, its manufacture is so energy intensive that one could argue that it is in fact a de facto non-renewable energy source. The same holds true for paper and plastic products.

For instance, when it comes to the synthesis of metals, great amounts of energy, manpower, and resources must be brought to bear. Every time metals are synthesized, massive amounts of heat are applied to melt them into rivers of molten materials, which can span the course of several football fields in length. Throughout this process, these rivers of molten steal are cooled, molded, treated, re-heated, and put through a panoply of other treatments to create an end product ready for distribution and fabrication.

Mindful of the foregoing costs associated with the production of these resources, governments around the world have uniformly agreed that aggressive public policies should be undertaken to mitigate and lower these costs through recycling programs. Although recycling does not function without significant amounts of labor, treatments, and other attendant methods and protocols, it is certainly a more cost-effective solution to meeting the exponentially increasing demands of a burgeoning world population.

Pursuant to these efforts, many schools and universities, as well as private sector companies have placed several class-specific refuse receptacles in order to encourage the orderly collection of discarded materials. For instance, some schools will have color-coded waste receptacles with indicia indicating that it is meant only for aluminum cans. Others indicate in alternating cases glass, paper, plastic, etc.

Despite these efforts, there have been attendant issues, which have figured largely into the monetization of these efforts. Typically, these institutions would prefer to recycle, and subsequently monetize the commoditization of the cans, paper, etc. to help fund various programs. However, some people have found that they can easily tap into these recycling receptacles for quick money, instead of haphazardly scavenging around for these resources.

Therefore, what is needed is an apparatus, which can help encourage the recycling of cans, glass, etc. into aesthetic housings in an orderly fashion.

### SUMMARY

In general, in a first aspect, the Housing for Refuse and/or Recycling Receptacles features a Pre-Scored Cardboard Planar Member with several scorings to enable the same to be folded into a housing which can be placed over a refuse, or recycling receptacle. This apparatus bears a strong resemblance to a basketball hoop to make it entertaining and encouraging for people to recycle their discarded items.

It is also an object of the embodiments described herein to provide for a housing, which is more aesthetic and congruent with the surrounding buildings. Oftentimes, most trash or recycling receptacles can be discordant eye sores which ruin the architectural look which was intended, whereas a housing which can blend in with the walls would be better. Moreover, in various embodiments, the panels may further comprise various advertising indicia, or indicia encouraging the recycling, and proper sorting of various items.

The features and advantages described in this summary and the following detailed description are not all-inclusive. Many additional features and advantages will be apparent to one of ordinary skill in the art in view of the drawings, specification, and claims thereof.

### BRIEF DESCRIPTION OF THE DRAWING FIGURES

FIG. 1 is a perspective view of an embodiment.

FIG. 2 is a planar view of an embodiment.

FIG. 3 is a side elevation view of an embodiment.

FIG. 4 is a rear elevation view of an embodiment.

FIG. 5 is a side elevation view of an embodiment.

FIG. 6 is a perspective view of an embodiment.

FIG. 7 is a planar view of an embodiment.

FIG. 8 is a planar view of an embodiment.

FIG. 9 is a planar view of an embodiment.

FIG. 10 is a perspective view of an embodiment.

FIG. 11 is a planar view of an embodiment.

FIG. 12 is a planar view of an embodiment.

FIG. 13 is a perspective view of an embodiment.

FIG. 14 is a planar view of an embodiment.

FIG. 15 is a perspective view of an embodiment.

### DETAILED DESCRIPTION

According to an embodiment of the present invention, a unique Housing for Refuse and/or Recycling Receptacles is provided for the purpose of providing an aesthetic and functional covering for trash and/or recycling receptacles. The embodiments are described in enabling detail below.

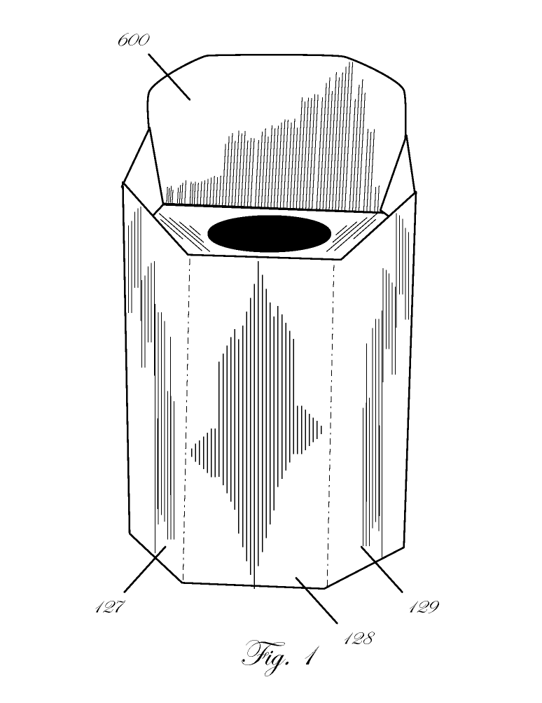

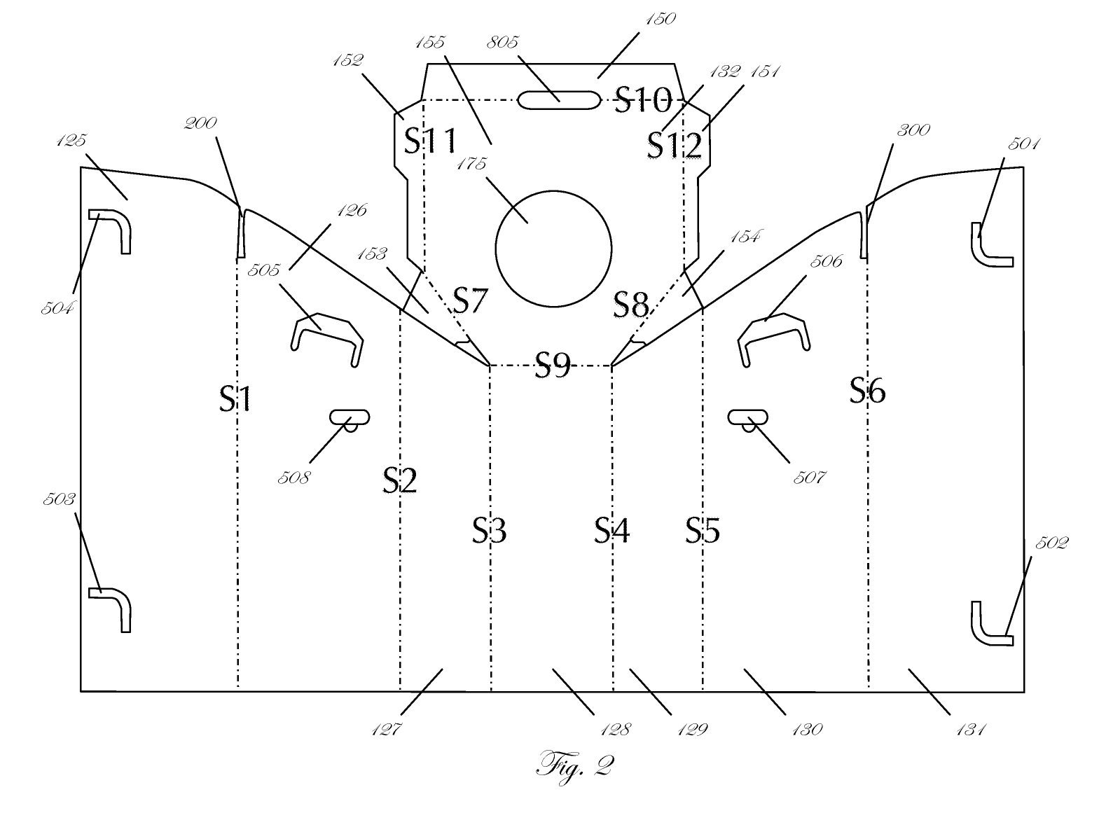

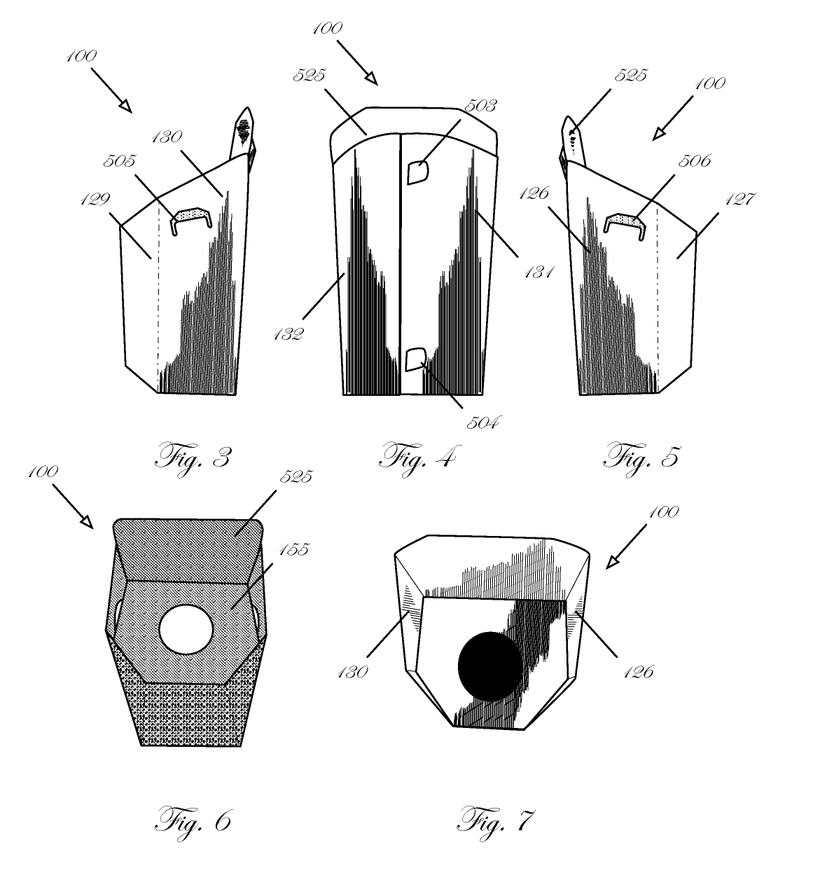

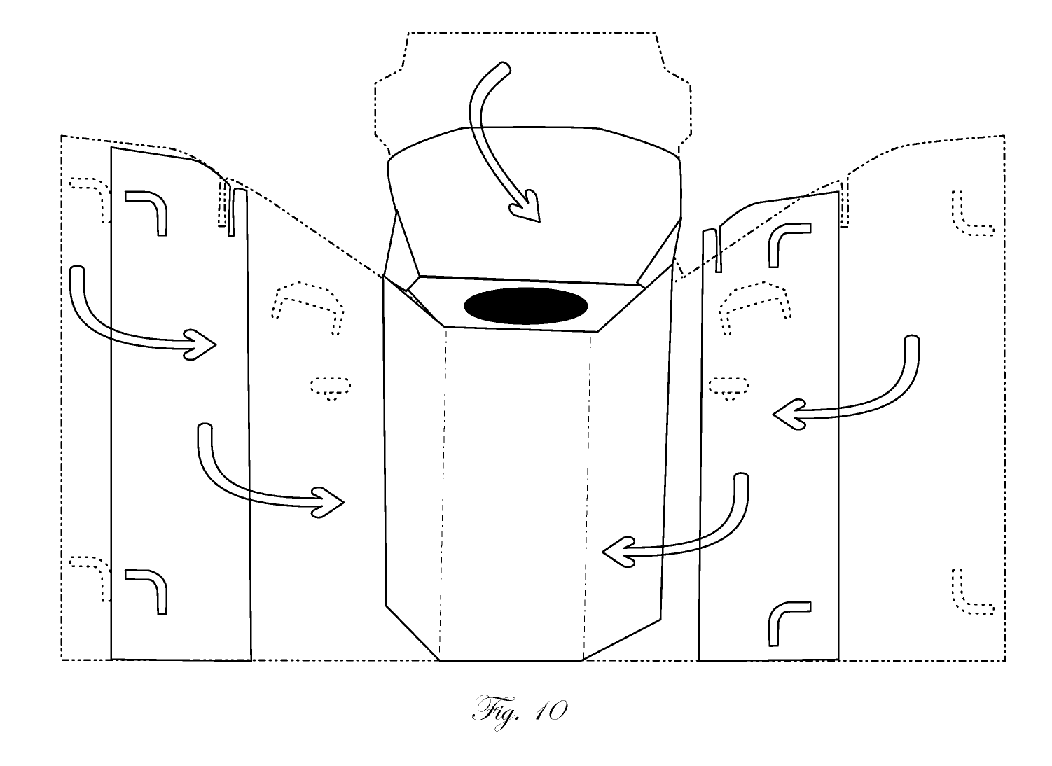

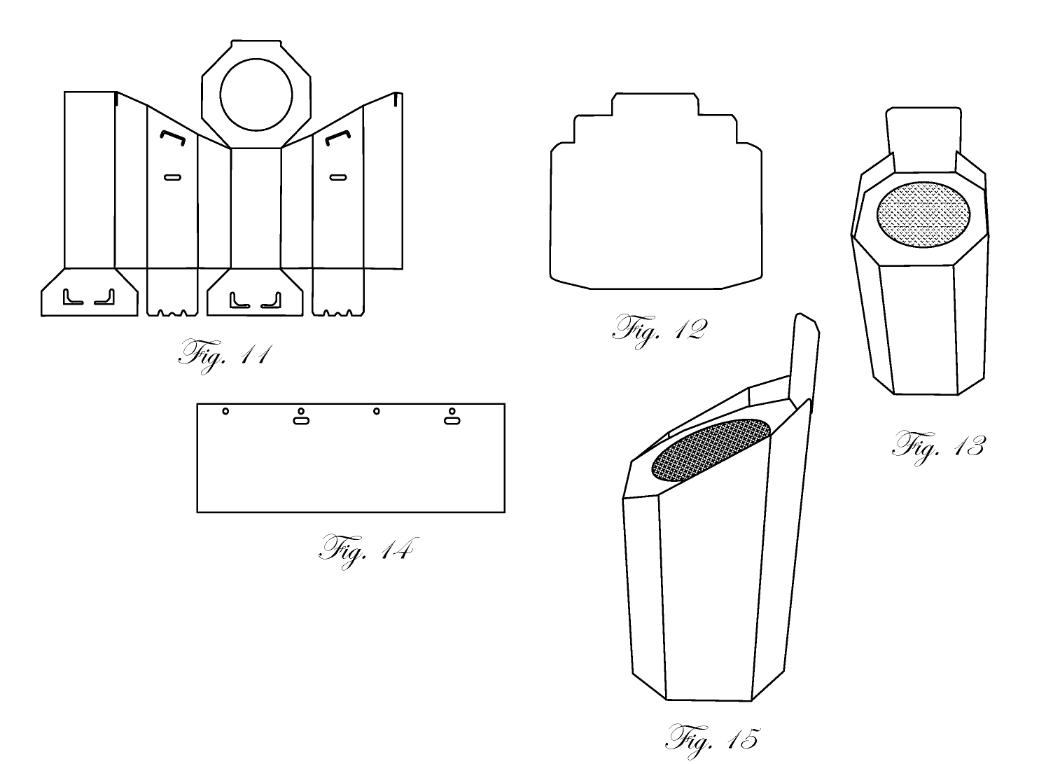

FIG. 1 illustrates a Housing for Refuse and/or Recycling Receptacles 100. In one embodiment, the Housing for Refuse and/or Recycling Receptacles 100 includes a Pre-Scored Cardboard Planar Member 101. The Pre-Scored Cardboard Planar Member has a plurality of scorings, a plurality of cutouts, a plurality of notches, and a plurality of panels. FIGS. 11-15 illustrate similar implementations of an embodiment.

According to one embodiment as depicted in FIG. 2, the Pre-Scored Cardboard Planar Member comprises a first scoring S1, a second scoring S2, a third scoring S3, a fourth scoring S4, a fifth scoring S5, a sixth scoring S6, and a vertical scoring S9. These scorings enable a user to easily and accurately fold the planar member in order to engage the various edges of the planar member to dovetail into each other thereby forming the housing.

The scorings can be formed through a panoply of methods. They can be formed through a series of perforated punctures which creates a series of incisions along an axis. In other embodiments, the scorings can be made by simply pressing the folds along an axis employing various factory equipment made specifically for such scorings. The embodiments described herein do not require or favor one method of scoring over another. The type of scorings employed in the embodiments herein will depend largely upon the type of cardboard, or similar material used.

FIG. 2 also illustrates that the Pre-Scored Cardboard Planar Member comprises a first cutout 505, a second cutout 506, a third cutout 507, and a fourth cutout 508. These cutouts are essentially orifices with which various panels may be able to mate or dovetail with each other.

The Pre-Scored Cardboard Planar Member comprises a first dovetailing notch 200 and a second dovetailing notch 300. The first dovetailing notch is disposed between the first panel and the second panel whereas the second dovetailing notch is disposed between the sixth panel and the seventh panel.

The Pre-Scored Cardboard Planar Member comprises a first panel 125, a second panel 126, a third panel 127 a fourth panel 128, a fifth panel 129, a sixth panel 130, a seventh panel 131, and a vertical panel 155. The vertical panel is sized to engage with the first and second notches.

FIG. 2 also illustrates that in one embodiment, the vertical panel may further comprise a first vertical scoring S9, a second vertical scoring S11, a third vertical scoring S12, and a lip scoring S10. The lip scoring engages with a section between the second, third, fifth and sixth vertical panels. The regions circumscribed between the second vertical scoring S11, and the third vertical scoring S11 are folded and translated upon the Z-Axis (going forward towards the viewer) and engage with the first and second notches. The vertical panel may further comprise a vertical panel orifice 175. The vertical panel orifice enables users, pedestrians, etc. to place various discard-able items such as trash, or recycle-able materials such as soda bottles, cans, paper, etc. so they fall directly over the trash can underneath. The vertical panel orifice is sized, disposed, and positioned along the Z-Axis to lie directly over the trash receptacle disposed underneath.

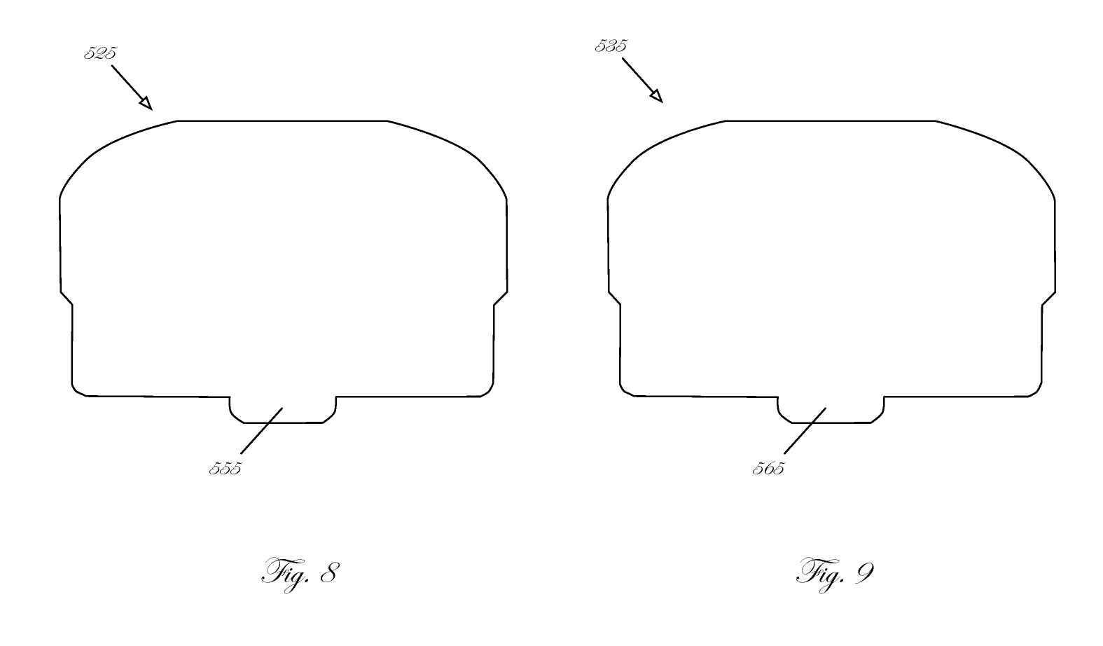

FIGS. 8-9 illustrates that a first header 525 and a second header 535 may further comprise one embodiment. The headers are affixed to the apparatus through a header orifice 805 disposed near the lip of the vertical panel. Each header has a dovetailing end 555, 565 sized to fit and create an interference fit with the header orifice. Each header acts as, or is analogous to a backboard of a basketball hoop assembly. In the event a person throws their refuse and it hits the header, the refuse may ricochet off the header and fall into the vertical panel orifice.

It will be apparent to the skilled artisan that there are numerous changes that may be made in embodiments described herein without departing from the spirit and scope of those embodiments. As such, the embodiments taught herein by specific examples are limited only by the scope of the claims that follow.

What is claimed is:

1. A Housing for Refuse and/or Recycling Receptacles comprising:
a Pre-Scored Cardboard Planar Member having a plurality of scorings, a plurality of cutouts, a plurality of notches, and a plurality of panels;
the Pre-Scored Cardboard Planar Member comprises a first scoring, a second scoring, a third scoring, a fourth scoring, a fifth scoring, a sixth scoring, and a vertical scoring;
the Pre-Scored Cardboard Planar Member comprises a first cutout, a second cutout, a third cutout, and a fourth cutout;
the Pre-Scored Cardboard Planar Member comprises a first dovetailing notch and a second dovetailing notch;
the Pre-Scored Cardboard Planar Member comprises a first panel, a second panel, a third panel, a fourth panel, a fifth panel, a sixth panel, a seventh panel, and a vertical panel;
the first dovetailing notch is disposed between the first panel and the second panel;
the second dovetailing notch is disposed between the sixth panel and the seventh panel;
the vertical panel is sized to engage with the first and second notches.

2. The Housing for Refuse and/or Recycling Receptacles of claim 1 further comprising a plurality of vertical panel scorings; the vertical panel comprises a first vertical scoring, a second vertical scoring, a third vertical scoring, and a lip scoring;
the lip scoring engages with a section between the second, third, fifth and sixth vertical panels.

3. The Housing for Refuse and/or Recycling Receptacles of claim 1 further comprising a vertical panel orifice.

4. The Housing for Refuse and/or Recycling Receptacles of claim 1 further comprising a first header.

5. The Housing for Refuse and/or Recycling Receptacles of claim 1 further comprising a second header.
